(19) United States
(12) Patent Application Publication
(10) Pub. No.: US 2014/0008579 A1
(43) Pub. Date: Jan. 9, 2014

(54) PRODUCTION OF SYNTHESIS GAS THROUGH THE USE OF A SOLAR RECEIVER DECOUPLED FROM A REFORMING REACTOR

(71) Applicant: Commonwealth Scientific and Industrial Research Organisation, Parkville (AU)

(72) Inventor: Robbie MCNAUGHTON, North Ryde (AU)

(21) Appl. No.: 13/917,197

(22) Filed: Jun. 13, 2013

(30) Foreign Application Priority Data
Jun. 13, 2012 (AU) 2012902467
Jul. 19, 2012 (AU) 2012903071

(51) Int. Cl. C01B 3/26

(52) U.S. Cl. CPC C01B 3/26
USPC 252/373; 422/162

(57) ABSTRACT

A process for the production of syngas comprising the steps of: forming a gaseous reactant mixture comprising a hydrocarbon fuel; reforming the reactant mixture in a reforming reactor at a target reforming temperature to produce hydrogen gas, the reactant mixture is heated by a heat transfer fluid that, prior to heating the reactant mixture, passes through a concentrated solar energy receiver. The volumetric ratio of heat transfer fluid between the receiver and the reforming reactor to the heat transfer fluid in the receiver is less than fifty.

### TECHNICAL FIELD

The present invention relates to a process for producing synthesis gas (syngas) from concentrated solar energy and an apparatus thereof. More particularly, the invention relates to a reforming reactor which sources its energy requirement from a high temperature solar receiver via a heat transfer fluid.

### BACKGROUND TO THE INVENTION

The following discussion of the background to the invention is intended to facilitate an understanding of the invention. However, it should be appreciated that the discussion is not an acknowledgement or admission that any of the material referred to was published, known or part of the common general knowledge as at the priority date of the application.

Solar derived syngas has been demonstrated in various projects around the world since the 1980s. Syngas is the product of a reforming reaction, which produces hydrogen gas by the reforming chemical reaction:

CH₄+H₂O=3H₂+CO (1)

The yield of hydrogen gas may be increased by reacting the primary reacted gas flow with a secondary water flow to produce additional hydrogen gas in a secondary reacted gas flow. This reaction may be conveniently performed in a water gas shift reactor according to the shift reaction:

CO+H₂O═H₂+CO₂ (2)

The net result of the reforming reaction and the shift reaction is given by the relation:

CH₄+2H₂O=4H₂+CO₂ (3)

The result is four moles of hydrogen gas produced for each mole of methane introduced.

Depending upon the nature of the feedstock containing the hydrocarbon fuel, a dry reforming reaction may also take place according to the following reaction:

CH₄+CO₂═H₂+2CO (4)

Mixed reforming reactions of formula (1), (2) and (4) may also occur, dependent upon the nature of the feedstock.

The highly endothermic reforming chemical reactions (1) and (4) are performed at the reforming temperature in the presence of a suitable reforming catalyst. To provide the necessary heat input, the carbon-hydrogen-containing species and the water are heated to the reforming temperature with solar energy. The solar energy is in a concentrated form derived from heliostat fields or the like. The concentrated solar energy is typically focused upon a solar receiver, which also functions as a reforming reactor.

One of the challenges of running a directly illuminated solar syngas process is the variable nature of the solar flux profile on the receiver during the course of the day and throughout the year. This makes the design of the receiver geometry challenging with localised temperature gradients within the receiver resulting in thermal stresses which comprise the longevity of the receiver. Furthermore, temperature variation within the catalyst bed may result in detrimental performance.

This problem is partially addressed in U.S. Pat. No. 7,537,750, which discloses a process in which heliostats are used to concentrate solar energy and transfer heat to a molten metal via a solar receiver which functions as a heat exchanger. The molten metal flows into a holding tank which functions as a heat sink thereby regulating the temperature of the molten metal leaving the holding tank to heat a separate reforming reactor to the required reaction temperature. While the process decouples the solar receiver from the reforming reactor, thereby solving the problems of solar flux variation, there are a number of problems with this process. Firstly, the process is prone to excessive heat loss due to the extensive pipe work and storage tanks required to transport the molten metal from the solar tower to the storage tanks and then to the reforming reactors. Due to this design the maximum temperature of the reforming reactor will always be significantly below the temperature of the molten metal emanating from solar receiver. Secondly, due to the large volumes of molten metal required to fill the two storage tanks and pipe work, the process is not easily returned to operation after repairs or maintenance, with the threat of solidification of the molten metal, thus resulting in the need for excessive overdesign and control measures.

Accordingly, there is a need for a solution to at least address some of the abovementioned problems.

### SUMMARY OF THE INVENTION

A first aspect of the present invention provides a process for the production of syngas comprising the steps of:
a. forming a gaseous reactant mixture comprising a hydrocarbon fuel;
b. reforming the reactant mixture in a reforming reactor at a target reforming temperature to produce hydrogen gas, the reactant mixture is heated by a heat transfer fluid that, prior to heating the reactant mixture, passes through a concentrated solar energy receiver,

wherein the volumetric ratio of heat transfer fluid between the receiver and the reforming reactor to the heat transfer fluid in the receiver is less than fifty.

The advantage of this configuration is that the reforming reactor temperature can be responsively controlled using a relatively small amount of heat transfer fluid, thereby minimising heat losses and improving overall solar energy conversion.

The hydrocarbon fuel may be any fuel comprising a hydrogen-carbon species that is capable of being reformed to produce hydrogen gas, including methane, ethanol and/or methanol. The hydrocarbon fuel is preferably methane or a methane containing gas such as natural gas or biogas.

The reforming reaction preferably includes at least a steam reforming reaction (formula 1) or a dry reforming reaction (formula 4). Depending upon the reforming reaction, the output stream of the reforming reactor will typically comprise varying amounts of carbon monoxide, carbon dioxide, hydrogen, water and methane.

Preferably, the volumetric ratio of heat transfer fluid between the receiver and the reforming reactors to heat transfer fluid in the receiver is less than twenty (20), more preferably less than ten (10) and even more preferably less than five (5). Through reducing the volume of heat transfer fluid between the receiver and the reforming reactor relative to the volume of heat transfer fluid within the receiver, process design is simplified and heat losses minimised. The lower limit of the volumetric ratio will be dictated by the ability to sufficiently change the temperature of the heat transfer fluid to enable the desired target reforming temperature range to be reached. Typically, a lower limit ratio would be at least 0.01, more preferably at least 0.1, even more preferably at least 0.5 and yet even more preferably at least 1.0.

The process preferably further comprises a heat exchanger between the receiver and the reforming reactor. The heat exchanger may be used to heat the heat transfer fluid to within a target reforming temperature range. The heat exchanger supplements the thermal flux provided by the solar receiver to thereby control the temperature of the heat transfer fluid to be within the desired target reforming temperature range.

Preferably, the volume of the heat transfer fluid between the receiver and the heat exchanger or reforming reactor is such that the temperature difference is less than 10° C., more preferably less than 5° C. and even more preferably less than 3° C. The lower the drop in temperature between the receiver and the heat exchanger or reforming reactor the lower the heat losses from the process. To reduced heat losses the piping between the receiver and the heat exchanger is preferably insulated.

The reforming reactor is preferably designed to enable the heat transfer fluid to heat the reforming reactor while avoiding localised temperature gradients within the reforming reactor. A reforming reactor of a “shell and tube” type is suitable.

Variations in the temperature of the heat transfer fluid entering the reforming reactor may be detrimental to achieve steady state processing conditions and hence optimal performance. To address this issue, the process preferably further comprises a control system, wherein the target reforming temperature entering the reforming reactor is controlled by varying at least one, preferably at least two, even more preferably at least three; and most preferably all of the following parameters:
a. mass flowrate of the reactant mixture;
b. mass flowrate of the heat transfer fluid;
c. thermal flux of the solar energy receiver; and
d. thermal flux of the heat exchanger.

The heat flux of the solar energy receiver is dependent upon the amount of solar energy radiated from the heliostat field or the like. The solar energy radiated by the heliostat field fluctuates with both the time of the day and seasonal conditions. In comparison the heat flux of the heat exchanger is typically and preferably accurately controllable (e.g. through controlling the rate of fuel used to supply heat to the heat exchanger).

In a preferred embodiment, the target reforming temperature is controlled by a cascade control loop using the thermal flux of the receiver as an input to control the thermal flux of the heat exchanger. Within this embodiment, the heat exchanger may only contribute heat flux to the heat transfer fluid (i.e. raise the temperature of the heat transfer fluid) once the target reforming temperature drops to a lower limit of a target reforming temperature range.

Preferably, the thermal flux of the solar energy receiver is calibrated and controlled through the adjustment of one of more heliostats that supply concentrated solar energy to the receiver.

In one embodiment, the solar energy receiver defines a primary target to receive directed sunlight from a field of heliostats each mounted for angular adjustment to optimally receive a beam of sunlight and direct it to the primary target of the solar energy receiver, the receiver is calibrated through the steps comprising:
a. during operation of the solar energy apparatus, sequentially causing a temporary angular adjustment of the respective said heliostats so as to divert the beam of sunlight received at each heliostat to a secondary target for a predetermined period of time, which secondary target is at or spaced from the primary target and disposed so as not to be intercepted by said optimally received and directed beams of sunlight,
b. thereafter returning the heliostat to a position in which the received beam of sunlight is directed to the primary target,
c. recording a representation of each directed beam at the secondary target;
d. responding to the representation of the diverted beam for the respective heliostats when a parameter or element thereof deviates from a reference norm, by angularly adjusting the corresponding heliostat to improve the accuracy of its receipt of said beam of sunlight and direction of the beam to the primary target, thereby compensating by closed loop control of the field of heliostats during operation of the apparatus for tolerances in heliostat and actuator geometries; and
e. causing a said representation to be acquired for each of multiple heliostats at different times over a day and over an extended period of multiple days and for corresponding angular positions of the heliostat, whereby to obtain a calibration model for the heliostats with respect to multiple time points as well as the geometry of the heliostats, and whereby to achieve a combination of open loop and closed loop control of the positions of the heliostats.

Within this embodiment, said extended period of multiple days preferably comprises a time scale of several months.

Preferably, said representation is acquired for each of multiple heliostats at different times over a day at intervals of a plurality of months.

Preferably, said obtaining of the calibration model includes use of a weighted and constrained gradient descent method.

Preferably said angular adjustment of the corresponding heliostat comprises an offset selected from a set of offsets determined by calibration measurements taken at multiple time points over a day.

Through use of a control system which regularly calibrates the heliostat fields to take into account imprecision in the installation and operation of the heliostat field as well as account for seasonal variations, the heat flux of the receiver may be accurately controlled. Accordingly, the temperature of the heat transfer fluid and correspondingly the target reforming reaction temperature may be accurately controlled without the need to use excessively large thermal storage tanks to minimise fluctuations of the target reforming temperature.

The heat transfer fluid may be a gas, a liquid (e.g. molten salt) or a phase change (gas/liquid) material. Preferably, the heat transfer fluid is a suitable inert gas. Preferably the gas is selected from the group consisting of air, CO₂, xeon, argon, neon, methane, helium and hydrogen. Through using a gaseous heat transfer fluid, the heat transfer fluid has a relatively low heat capacity compared to liquid heat transfer fluids. This enables the heat exchanger to be more responsive in adjusting the target reforming temperature.

The target reforming temperature range depends upon the catalyst system employed in the reforming reactor. Preferably, the target reforming temperature is between 500° C. to 900° C.

In a second aspect, the present invention provides an apparatus for the production of syngas comprising:

a solar energy receiver for receiver solar energy and transferring said energy to a heat transfer fluid; and

a reforming reactor for reacting a gaseous reactant mixture comprising a hydrocarbon fuel and water, the reactant mixture heated by said heat transfer fluid, wherein the volumetric ratio of heat transfer fluid between the receiver and the reforming reactor to heat transfer fluid in the receiver is less than fifty.

The apparatus of the second aspect of the present invention preferably operates using the process of the first aspect of the present invention.

In some embodiments, the apparatus further comprising a heat exchanger between the receiver and the reforming reactor, said heat exchanger used to heat the heat transfer fluid to within a target reforming temperature range.

In some embodiments, the apparatus further comprises a control system, wherein the target reforming temperature is controlled by varying at least one of the following parameters:
a. mass flowrate of the reactant mixture;
b. mass flowrate of the heat transfer fluid;
c. thermal flux of the solar energy receiver; and
d. thermal flux of the heat exchanger.

The control system preferably calibrates the thermal flux of the solar energy receiver and wherein the solar energy receiver defines a primary target to receive directed sunlight from a field of heliostats each mounted for angular adjustment to optimally receive a beam of sunlight and direct it to the primary target of the solar energy receiver, the receiver is calibrated through the steps comprising:

during operation of the solar energy apparatus, sequentially causing a temporary angular adjustment of the respective said heliostats so as to divert the beam of sunlight received at each heliostat to a secondary target for a predetermined period of time, which secondary target is at or spaced from the primary target and disposed so as not to be intercepted by said optimally received and directed beams of sunlight,

thereafter returning the heliostat to a position in which the received beam of sunlight is directed to the primary target, recording a representation of each directed beam at the secondary target;

responding to the representation of the diverted beam for the respective heliostats when a parameter or element thereof deviates from a reference norm, by angularly adjusting the corresponding heliostat to improve the accuracy of its receipt of said beam of sunlight and direction of the beam to the primary target, thereby compensating by closed loop control of the field of heliostats during operation of the apparatus for tolerances in heliostat and actuator geometries; and

causing a said representation to be acquired for each of multiple heliostats at different times over a day and over an extended period of multiple days and for corresponding angular positions of the heliostat, whereby to obtain a calibration model for the heliostats with respect to multiple time points as well as the geometry of the heliostats, and whereby to achieve a combination of open loop and closed loop control of the positions of the heliostats.

### BRIEF DESCRIPTION OF THE DRAWINGS

The present invention will now be described with reference to the figures of the accompanying drawings, which illustrate particular preferred embodiments of the present invention, wherein:

FIG. 1 is a schematic diagram of one embodiment of the process of the present invention;

FIG. 2 is a view of a small central receiver solar energy collection system according to an embodiment of the invention;

FIG. 3 is a plan diagram of a suitable field of heliostats for the system depicted in FIG. 2;

FIG. 4 is a perspective view from below of the tower-mounted central receiver and the secondary target;

FIG. 5 is a functional block diagram of the main components of the solar energy collection system, including the controller;

FIG. 6 is a diagram of the secondary target with a representative flux image of a heliostat-reflected beam; and

FIG. 7 is a diagrammatic representation of the closed loop control system.

### DETAILED DESCRIPTION OF ONE EMBODIMENT OF THE INVENTION

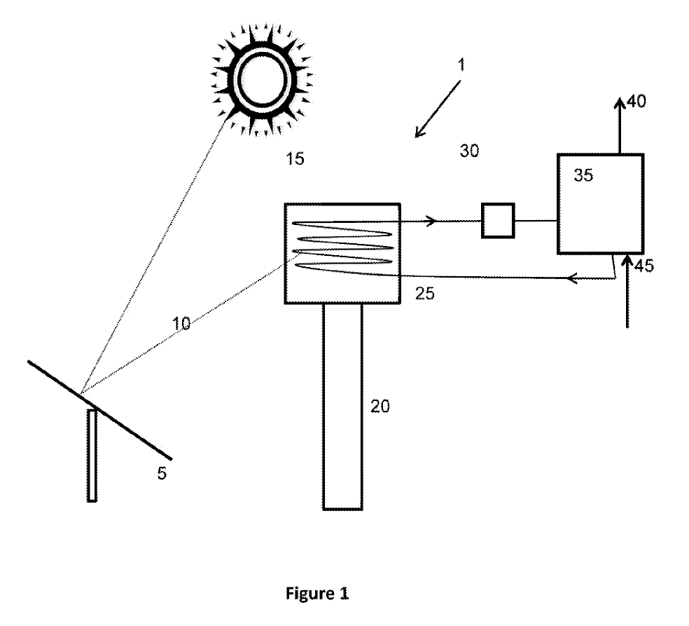

With reference to FIG. 1, there is a process to produce syngas 1, comprising a heliostat field 5, which concentrates solar energy 10 to a solar energy receiver 15 located on a tower 20. The receiver typically comprises a pipe 25 containing a heat transfer fluid which passes through the concentrated solar energy receiver 15 and a heat exchanger 30 prior to entering a reforming reactor 35.

The volume of the heat transfer fluid within the receiver may be readily determined through assessing the volume of volumetric flow path (e.g. pipework) between the inlet and outlet which constitutes the receiver. The boundaries of the receiver should be apparent to those skilled in the art. However, to avoid doubt the inlet of the receiver would be the point at which the heat transfer fluid is first exposed to solar heat flux and the outlet is the point at which the heat transfer fluid is no longer exposed to the concentrated solar heat flux.

The distance between the receiver and the reforming reactor may be determined by the volumetric flow path between the outlet of the receiver and the inlet of the reforming reactor. Once again the inlet of the reforming reactor will be readily identified by the person skilled in the art.

The solar energy receiver 15 may be any receiver design which is capable of heating the heat transfer fluid to within the target reforming temperature range. This range may vary from 500° C. to 900° C. depending upon the catalyst system employed in the reforming reactor.

The heat exchanger 30 preferably transfers heat which has been generated by means of a carbon-hydrogen containing material which is also used as a reactant to the reformer. To maximise the energy efficiency of the process, the heat exchanger is preferably used as a contingency means of preventing the target reforming reaction temperature dropping below a level at which the process performance drops to an extent which justifies the employment of the heat exchanger.

The reforming reactor 35 is preferably a shell and tube reactor in which the heat transfer fluid transfers heat within the shell of the reactor to the one or more tubes, which function as reaction vessels. Each of the tubes preferably comprises a reforming catalyst for catalysing the reforming reaction according to at least formula (1) or (4). The reforming reactor is preferably arranged in a counter current configuration with the incoming heat transfer fluid contacting the outgoing reactant/product mixture 40. The outgoing heat transfer fluid may be used to preheat the incoming reactant mixture 45 prior to the reactant mixture entering the reactor 35. Alternatively, the incoming reactant mixture is preheated by the outgoing reactant/product stream 40.

In one embodiment, the hydrocarbon fuel (e.g. methane) which is used as a reactant to the reforming reactor 35 is also used as a heat transfer fluid. Within this embodiment, a portion of heat transfer fluid is diverted from the heat transfer fluid exiting the receiver 15 to the reactant stream 45. The volume of heat transfer fluid is maintained through preferably replenishing the diverted heat transfer fluid immediately prior the heat transfer fluid entering the receiver 15. This embodiment has the advantage of using the accurately known or controlled temperature of the heat transfer fluid exiting the receiver to control the temperature of the reactant stream entering the reforming reactor. The portion of the heat transfer fluid directed to the reactant stream may be added at the appropriate proportion relative to other reactants to avoid the need to use a separate heat exchanger to preheat the reactant stream.

The outgoing reactant/product mixture typically comprises hydrogen, carbon dioxide, carbon monoxide and water. To produce additional hydrogen, this mixture may be further reacted in a water gas shift reactor (not shown) as described in formula (2). The reforming and water gas shift reactors are preferably located on the tower 20 (i.e. the reactors are located at an elevated position above the ground and preferably on substantially the same plane as the solar energy receiver). By combining in close proximity all the unit operations directly linked to the heat transfer fluid, heat losses of the process may be minimised.

The heat transfer fluid which exits the reforming reactor flows back to the solar energy receiver where the heat transfer fluid is heated back to the required temperature to enable the reforming reactor to be maintained at the target reforming reactor temperature. The operating capacity range of the reforming reactor is preferably matched to the heating capability range supplied by the solar energy receiver. This enables the heat exchanger to function as a booster to supplement short term deficiencies in the heat output of the receiver, as opposed to the heat exchanger functioning as a base load supply.

### Control System

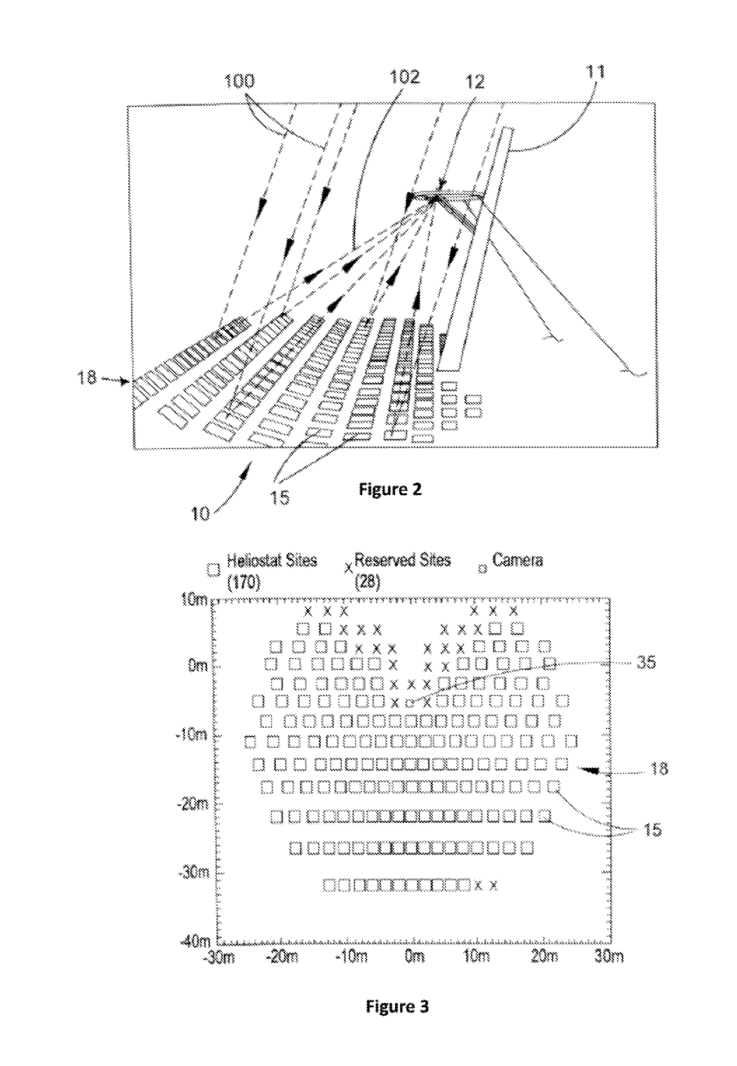

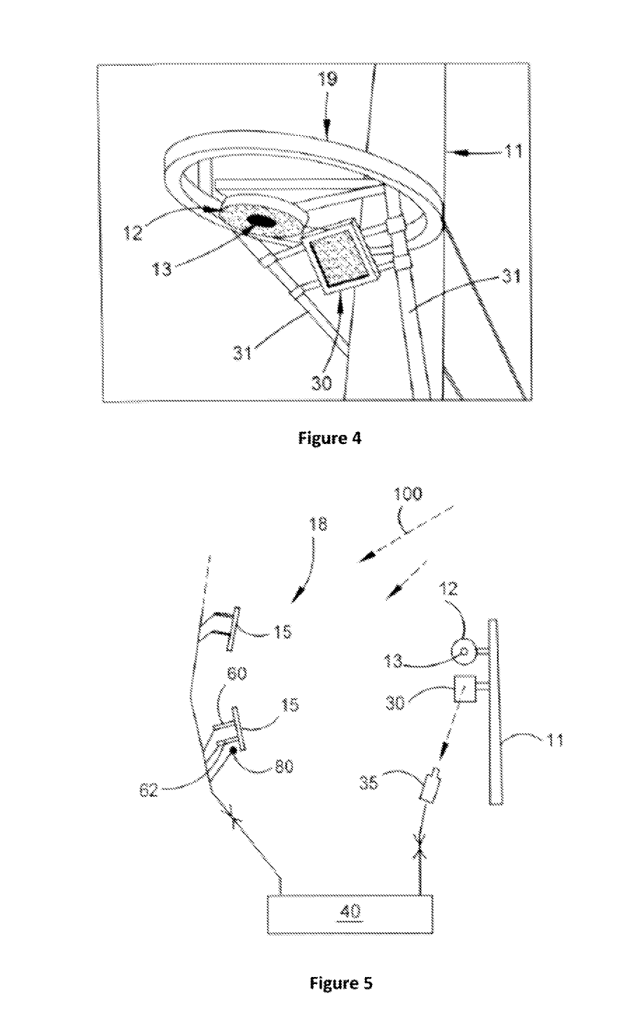

The present invention has particular utility when used in combination with a central receiver solar energy collection system utilising a combination of closed and open loop control and calibration. Such a system 10 is depicted in FIGS. 2 and 3. The system comprises a central solar energy receiver 12 mounted in cantilevered fashion from a tower 11 above and in front of a large array or field 18 of heliostats 15. Heliostats 15 are mounted for angular adjustment to optimally receive a respective beam of sunlight 100 and to direct the beam, as a directed beam 102, to the solar receiver 12. Receiver 12 has an aperture 13 (FIG. 4) that defines a primary target to receive the directed beams of sunlight from the heliostats.

An optimally receiving position in this context is the angular position of the heliostat determined by a central controller, discussed further below, to be the appropriate position at the particular time on the particular date at which the respective heliostat makes a desired contribution to the energy flux incident on the receiver target 13. In general, the objective is to best approximate the desired flux levels and flux distribution at the receiver.

Receiver 12 hangs downwardly from a supporting cantilever framework 19 fixed to tower 11. Also fitted to framework 19, by being suspended between a pair of inclined struts 31, is a secondary or auxiliary target 30 (FIG. 4). The secondary target is, in this case, spaced from the primary target and disposed so as not to be intercepted by the optimally received and directed beams of light from the heliostats. In this embodiment, the secondary target is a highly reflective rectangular surface on which is trained a camera 35. Camera 35 is mounted on the ground below the receiver at the position indicated in FIG. 3, and is designed to record a two-dimensional flux image representative of a cross-section of any sunlight beam that impinges on the secondary target.

Each heliostat 15, has an individual actuator system 21 typically comprising a pair of linear actuators 60, 62 (FIG. 5) for respectively controlling the inclination and declination of the heliostat's reflecting surface. The angular position of each heliostat, both inclination and declination, is determined by a central controller 40 (FIG. 5) which may comprise a suitable computer system. This controller is operably coupled to the actuators 60, 62 of all of the heliostats, to magnetic sensors 80 by which the controller is kept informed of the actual angular position co-ordinator of each heliostat, and to camera 35. As well as activating and deactivating the system 10 into and out of operation, controller 40 is programmed to carry out a number of calibration and control tasks in order to optimise the convertible energy received at primary target aperture 13.

An example of a functional small field central receiver solar energy collection system of the type depicted in FIGS. 2 to 5 is a close packed field of 170 heliostats of rectangular shape measuring about 2.4 metres by 1.84 metres and having a shallow concave reflecting surface with focal lengths between 15 and 38 metres, according to their position in the field. The field is designed for maximum annual energy collection by a receiver aperture 13 of diameter 0.8 m at an elevation of 17 metres at an angle of 17° to the horizontal. In an alternative arrangement there may be two receivers with associated apertures to which respective halves of the field 18 are focused during operation.

In this context “maximum energy collection” refers to maximising the energy during early morning and late afternoon times when one is typically using nearly 100% of the field to achieve the desired power level. The term also refers to how much light gets through the aperture 13, which is the total light reflected by the mirror minus the light hitting the shield around the aperture: the better the mirror of the heliostat is aimed, the less light is lost on the heat shield and more light gets through the aperture.

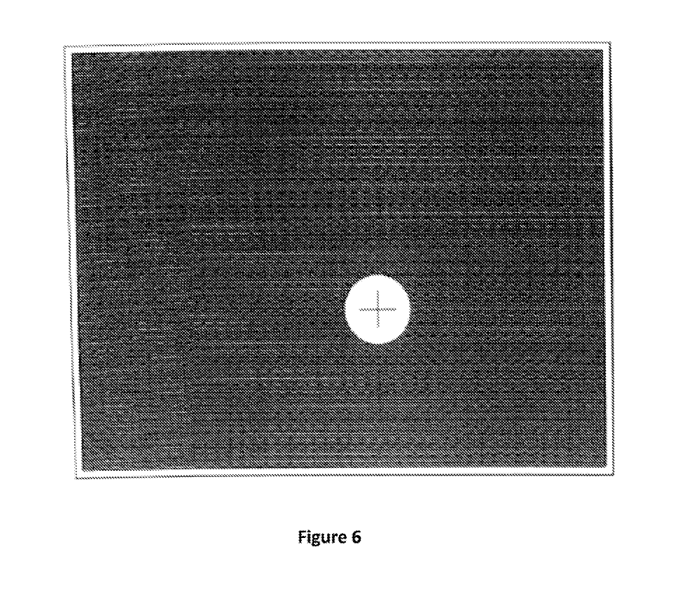

FIG. 6 is a photo of the secondary target bearing a representative flux image of a heliostat-reflected beam as it would be observed at secondary target 30 by camera 35. It can visually be seen that the energy flux centre (marked by the crosshairs) of the flux image is geometrically off-centre. The controller utilises any suitable known analytic tool to derive a geometric location of this centre, or centroid, of the flux image, and from this determines a correcting offset for the angular position of the respective heliostat.

Repetition of this process across all heliostats in turn during operation of the apparatus constitutes an “instantaneous” calibration of each heliostat and thus assists in real time optimisation of the focus of the reflected beams of sunlight onto the primary target aperture. Moreover, the arrangement is effective to improve the accuracy of receipt of the beam of sunlight and direction of the beam to the primary target, and so to compensate, by closed loop control during operation of the apparatus, for tolerances in heliostat and actuator geometries. It is preferred that calibration is continuously performed during solar plant operation by a controller managed program of sequentially taking each heliostat off primary target, directing its reflected beam to the secondary target 30, calibrating the heliostat, and adjusting its position to optimise the heliostat's contribution to the receiver aperture.

The flux image acquired by way of the camera 35 is also employed to calibrate a model of the heliostat geometry. The aforedescribed calibration measurements for each heliostat are taken at multiple time points over a day whereby to acquire a set of offsets. As just described, these offsets are used each time to offset the actuator, and thereby heliostat, positions to cause the respective beams to be more accurately located in the primary target aperture. Closed loop control of heliostat position is thereby achieved. Any errors in the modelled geometry will cause small errors as the beam is moved back from the secondary target to the receiver primary target aperture. The target offsets can be employed to calibrate the geometry errors (over a longer time scale) and once the geometry errors have been calibrated out, the average offset position will be close to zero. The combination of open loop (from calibrations) and closed loop (from offsets) positioning results in highly accurate tracking, allowing compensation for the employment of inexpensive heliostat actuation fabrication methods, and for the consequent substantial tolerances in heliostat and actuator geometries.

To develop a calibration model, model equations are formed that describe the effect of misalignments as a function of heliostat and therefore sun position. These misalignments include rotation of the primary axis away from true east-west, tilt of the primary axis from horizontal, and deviation from orthogonality between the pivot axes. The linear actuator geometry is formed by a triangle with two fixed sides and one side of variable length, so that three parameters (side A, side B and side C with actuator fully retracted) are sufficient to describe each actuator geometry. With the XYZ position of each mirror there are twelve calibration terms in all. Persons skilled in the art will appreciate that it is possible to perform coordinate rotations and combinations to reduce the dimensions of the model: it is found that seven of these twelve terms can be measured directly leaving five terms to be determined experimentally. In fact, in accordance with the preferred practice of this invention, three measurements over 4 hourly intervals repeated at 3-monthly intervals are sufficient to determine the unknown calibration constants. The preferred method for this purpose is to use a weighted and constrained gradient descent method, although those skilled in the art will appreciate that any of the standard non-linear or linearised regression methods may be employed.

During commissioning there is insufficient data over a time scale of months to accurately determine all constants, so the less well determined parameters are given low weights and tight constraints initially. The closed loop positioning method provides reasonable accuracy until enough months have elapsed to traverse sufficient calibration space to obtain an accurate calibration model.

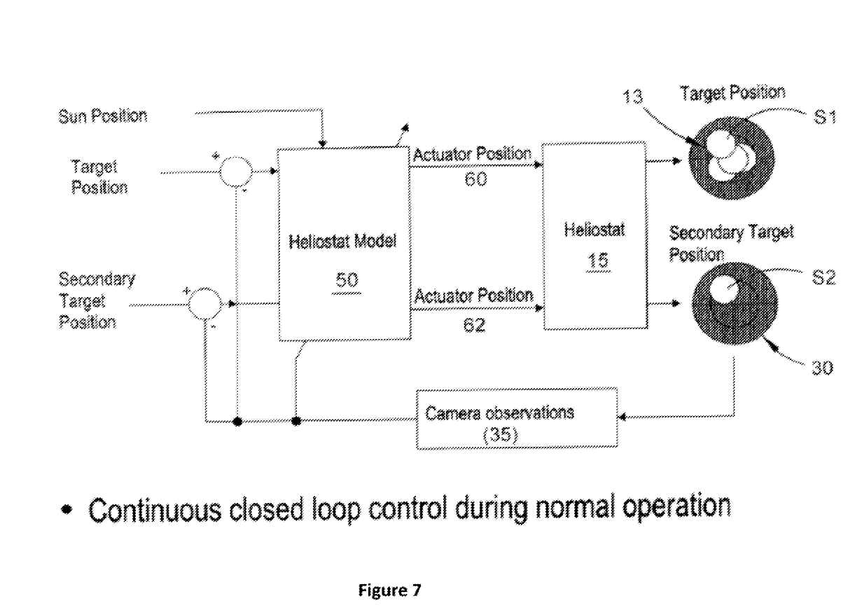

These concepts are elaborated upon diagrammatically in FIG. 7. Here, the discs S1 and S2 on the primary and second targets 13, 30 represent current image zones in which a selected percentage of the heliostat reflected energy is found. The image observed by the camera may be employed to determine an offset to adjust the relative positions on the targets and is also fed to the calibration model 50 for the respective heliostat. This diagram demonstrates the continuous closed loop control employed during normal operation of the central receiver solar energy collection system incorporating sequential adjustment, of each heliostat to direct its reflected beam to the secondary target.

Through the use of such a control and calibration system, the thermal flux transferred to the heat transfer fluid may be accurately controlled. In particular, through accurately knowing the thermal flux transferred to the heat transfer fluid from the solar receiver, the requirement of additional thermal, flux from the heat exchanger 30 may be controlled (e.g. via a cascade control loop) to ensure that the temperature of the heat transfer fluid entering the reforming reactor 35 is within the target reforming temperature range.

The control system may also have the ability to control the target reforming reactor temperature range through regulating the mass flow rate of the reactant mixture 45 and/or heat transfer fluid. Further details regarding the control and calibration system may be found in patent application PCT/AU2011/001687.

Those skilled in the art will appreciate that the invention described herein is susceptible to variations and modifications other than those specifically described. It is understood that the invention includes all such variations and modifications which fall within the spirit and scope of the present invention.

Where the terms “comprise”, “comprises”, “comprised” or “comprising” are used in this specification (including the claims) they are to be interpreted as specifying the presence of the stated features, integers, steps or components, but not precluding the presence of one or more other feature, integer, step, component or group thereof.

We claim:

1. A process for the production of syngas comprising the steps of:
a. forming a gaseous reactant mixture comprising a hydrocarbon fuel;
b. reforming the reactant mixture in a reforming reactor at a target reforming temperature to produce hydrogen gas, the reactant mixture being heated by a heat transfer fluid which, prior to heating the reactant mixture, passes through a solar energy receiver,
wherein the volumetric ratio of heat transfer fluid between the receiver and the reforming reactor to the heat transfer fluid in the receiver is less than fifty.

2. The process according to claim 1, further comprising a heat exchanger between the receiver and the reforming reactor, said heat exchanger used to heat the heat transfer fluid to within a target reforming temperature range.

3. The process according to claim 1, wherein the temperature difference between the heat transfer fluid exiting the receiver and the heat transfer fluid entering the reforming reactor or the heat exchanger is less than 10° C.

4. The process according to claim 1, further comprising a control system, wherein the target reforming temperature is controlled by varying at least one of the following parameters:
a. mass flowrate of the reactant mixture;
b. mass flowrate of the heat transfer fluid;
c. thermal flux of the solar energy receiver; and
d. thermal flux of the heat exchanger.

5. The process according to claim 4, wherein the target reforming temperature is controlled by a cascade control loop using the thermal flux of the receiver as an input to control the thermal flux of the heat exchanger.

6. The process according to claim 4, wherein the thermal flux of the solar energy receiver is controlled through the adjustment of one of more heliostats supply solar energy to the receiver.

7. The process according to claim 4, wherein the control system calibrates the thermal flux of the solar energy receiver, and wherein the solar energy receiver defines a primary target to receive directed sunlight from a field of heliostats each mounted for angular adjustment to optimally receive a beam of sunlight and direct it to the primary target of the solar energy receiver, the receiver is calibrated through the steps comprising:
during operation of the solar energy apparatus, sequentially causing a temporary angular adjustment of the respective said heliostats so as to divert the beam of sunlight received at each heliostat to a secondary target for a predetermined period of time, which secondary target is at or spaced from the primary target and disposed so as not to be intercepted by said optimally received and directed beams of sunlight,
thereafter returning the heliostat to a position in which the received beam of sunlight is directed to the primary target,
recording a representation of each directed beam at the secondary target;
responding to the representation of the diverted beam for the respective heliostats when, a parameter or element thereof deviates from a reference norm, by angularly adjusting the corresponding heliostat to improve the accuracy of its receipt of said beam of sunlight and direction of the beam to the primary target, thereby compensating by closed loop control of the field of heliostats during operation of the apparatus for tolerances in heliostat and actuator geometries; and
causing a said representation to be acquired for each of multiple heliostats at different times over a day and over an extended period of multiple days and for corresponding angular positions of the heliostat, whereby to obtain a calibration model for the heliostats with respect to multiple time points as well as the geometry of the heliostats, and whereby to achieve a combination of open loop and closed loop control of the positions of the heliostats.

8. The process according to claim 1, wherein the heat transfer fluid is a gas.

9. The process according to claim 8, wherein the gas is selected from the group consisting of carbon dioxide, air, xeon, argon, neon, nitrogen, helium, methane and hydrogen.

10. The process according to claim 2, wherein the target reforming temperature is between 500° C. to 900° C.

11. The process according to claim 1, wherein the receiver and the reforming reactor are located on a tower.

12. An apparatus for the production of syngas comprising:
a solar energy receiver for receiver solar energy and transferring said energy to a heat transfer fluid; and
a reforming reactor for reacting a gaseous reactant mixture comprising a hydrocarbon fuel and water, the reactant mixture heated by said heat transfer fluid,
wherein the volumetric ratio of heat transfer fluid between the receiver and the reforming reactor to heat transfer fluid in the receiver is less than fifty.

13. The apparatus according to claim 12, further comprising a heat exchanger between the receiver and the reforming reactor, said heat exchanger used to heat the heat transfer fluid to within a target reforming temperature range.

14. The apparatus according to claim 12, further comprising a control system, wherein the target reforming temperature is controlled by varying at least one of the following parameters:
a. mass flowrate of the reactant mixture;
b. mass flowrate of the heat transfer fluid;
c. thermal flux of the solar energy receiver; and
d. thermal flux of the heat exchanger.

15. The apparatus according to claim 14, wherein control system calibrates the thermal flux of the solar energy receiver and wherein the solar energy receiver defines a primary target to receive directed sunlight from a field of heliostats each mounted for angular adjustment to optimally receive a beam of sunlight and direct it to the primary target of the solar energy receiver, the receiver is calibrated through the steps comprising:
during operation of the solar energy apparatus, sequentially causing a temporary angular adjustment of the respective said heliostats so as to divert the beam of sunlight received at each heliostat to a secondary target for a predetermined period of time, which secondary target is at or spaced from the primary target and disposed so as not to be intercepted by said optimally received and directed beams of sunlight,
thereafter returning the heliostat to a position in which the received beam of sunlight is directed to the primary target,
recording a representation of each directed beam at the secondary target;
responding to the representation of the diverted beam for the respective heliostats when a parameter or element thereof deviates from a reference norm, by angularly adjusting the corresponding heliostat to improve the accuracy of its receipt of said beam of sunlight and direction of the beam to the primary target, thereby compensating by closed loop control of the field of heliostats during operation of the apparatus for tolerances in heliostat and actuator geometries; and
causing a said representation to be acquired for each of multiple heliostats at different times over a day and over an extended period of multiple days and for corresponding angular positions of the heliostat, whereby to obtain a calibration model for the heliostats with respect to multiple time points as well as the geometry of the heliostats, and whereby to achieve a combination of open loop and closed loop control of the positions of the heliostats.
